(19) United States
(12) Patent Application Publication
(10) Pub. No.: US 2016/0131342 A1
(43) Pub. Date: May 12, 2016

(54) Adjusting device for lamp

(71) Applicant: MEIRIC CHEN, New Taipei City (TW)

(72) Inventor: MEIRIC CHEN, New Taipei City (TW)

(21) Appl. No.: 14/538,826

(22) Filed: Nov. 12, 2014

(51) Int. Cl. F21V 19/02; F21V 21/06; F21S 6/00

(52) U.S. Cl. CPC F21V 19/02; F21S 6/003; F21V 21/06

(57) ABSTRACT

An adjusting device for a lamp contains: a base, a rotary arm, and an adjuster. The base includes a rotating shaft rotatably connected thereon, the rotary arm is mounted on the rotating shaft and includes an illuminating member fixed on one end thereof, such that the rotary arm is rotated along the rotating shaft and supports the illuminating member. The adjuster is disposed on one side of the base and includes an operating portion, a first decelerating mechanism, and a second decelerating mechanism. The first decelerating mechanism drives the second decelerating mechanism, the second decelerating mechanism drives the rotating shaft to rotate, and the operating portion is rotatably connected with the first decelerating mechanism to drive the first decelerating mechanism and the second decelerating mechanism to rotate, hence the second decelerating mechanism drives the rotating shaft to rotate, thus adjusting a height of the illuminating member relative to the base.

### FIELD OF THE INVENTION

The present invention relates to an adjusting device, and more particularly to an adjusting device for a lamp which adjusts a height of an illuminating member relative to a base and a distance between the illuminating member and the base.

### BACKGROUND OF THE INVENTION

A conventional adjusting device for a lamp (such as a table lamp) contains a flexible metal tube, wherein a first end of the metal tube is in connection with a base of the table lamp, and an illuminating member is fixed on a second end of the metal tube, such that the table lamp is manually moved toward a desired position or height relative to the base. However, a length of the metal tube is limited, thus limiting an adjusting range.

Another conventional adjusting structure for a lamp contains a connecting rod, and a first end of the connecting rod mechanism is rotatably coupled with a base, a second end of the connecting rod mechanism is joined with an illuminating member, wherein the connecting rod mechanism contains any one of four parallel connecting rods, a single connecting rod, and a multi-section connecting rod, such that the adjusting structure adjusts a height of the illuminating member relative to the base or a distance between the illuminating member and the base. However, such a conventional connecting rod mechanism is complicated and its rotating range is limited.

The present invention has arisen to mitigate and/or obviate the afore-described disadvantages.

### SUMMARY OF THE INVENTION

The primary object of the present invention is to provide an adjusting device for a lamp which adjusts a height of an illuminating member relative to a base and a distance between the illuminating member and the base easily.

To obtain the above objective, an adjusting device for a lamp provided by the present invention contains: a base, a rotary arm, and an adjuster.

The base includes a rotating shaft rotatably connected thereon, the rotary arm is mounted on the rotating shaft and includes an illuminating member fixed on one end thereof, such that the rotary arm is rotated along the rotating shaft and supports the illuminating member.

The adjuster is disposed on one side of the base and includes an operating portion, a first decelerating mechanism, and a second decelerating mechanism.

The first decelerating mechanism drives the second decelerating mechanism, the second decelerating mechanism drives the rotating shaft to rotate, and the operating portion is rotatably connected with the first decelerating mechanism to drive the first decelerating mechanism and the second decelerating mechanism to rotate, hence the second decelerating mechanism drives the rotating shaft to rotate, thus adjusting a height of the illuminating member relative to the base.

Preferably, each of the first decelerating mechanism and the second decelerating mechanism is a reduction gear mechanism.

Preferably, each of the first decelerating mechanism and the second decelerating mechanism is a friction wheel mechanism.

Preferably, each of the first decelerating mechanism and the second decelerating mechanism is a belt pulley mechanism.

The adjusting device for the lamp further contains a counterweight block secured on a second end of the rotary arm opposite to the illuminating member.

### BRIEF DESCRIPTION OF THE DRAWINGS

FIG. 1 is a diagram showing the assembly of an adjusting device for a lamp according to a first embodiment of the present invention.

FIG. 2 is a perspective view showing the assembly of the adjusting device for the lamp according to the first embodiment of the present invention.

FIG. 3 is a cross sectional view taken along lines III-III of FIG. 2.

FIG. 4 is a plan view showing the assembly of an adjusting device for a lamp according to a second embodiment of the present invention.

FIG. 5 is a plan view showing the assembly of an adjusting device for a lamp according to a third embodiment of the present invention.

FIG. 6 is a perspective view of an application of the adjusting device for the lamp according to the first embodiment of the present invention.

FIG. 7 is a perspective view of another application of the adjusting device for the lamp according to the first embodiment of the present invention.

### DETAILED DESCRIPTION OF THE PREFERRED EMBODIMENTS

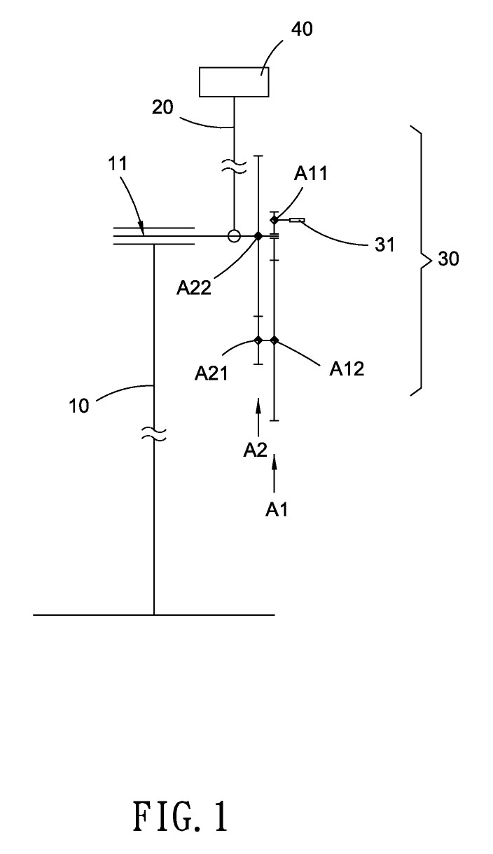

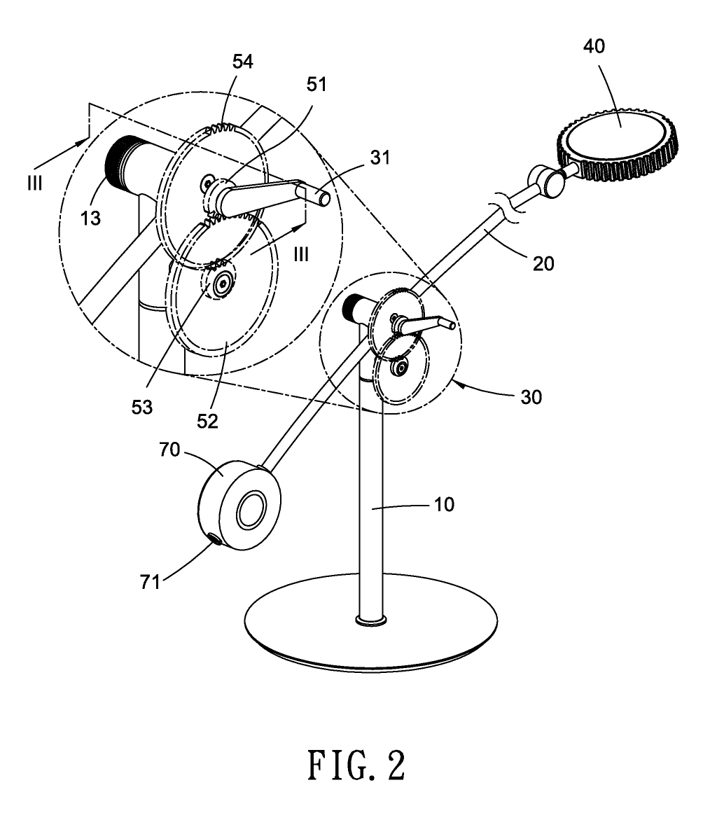

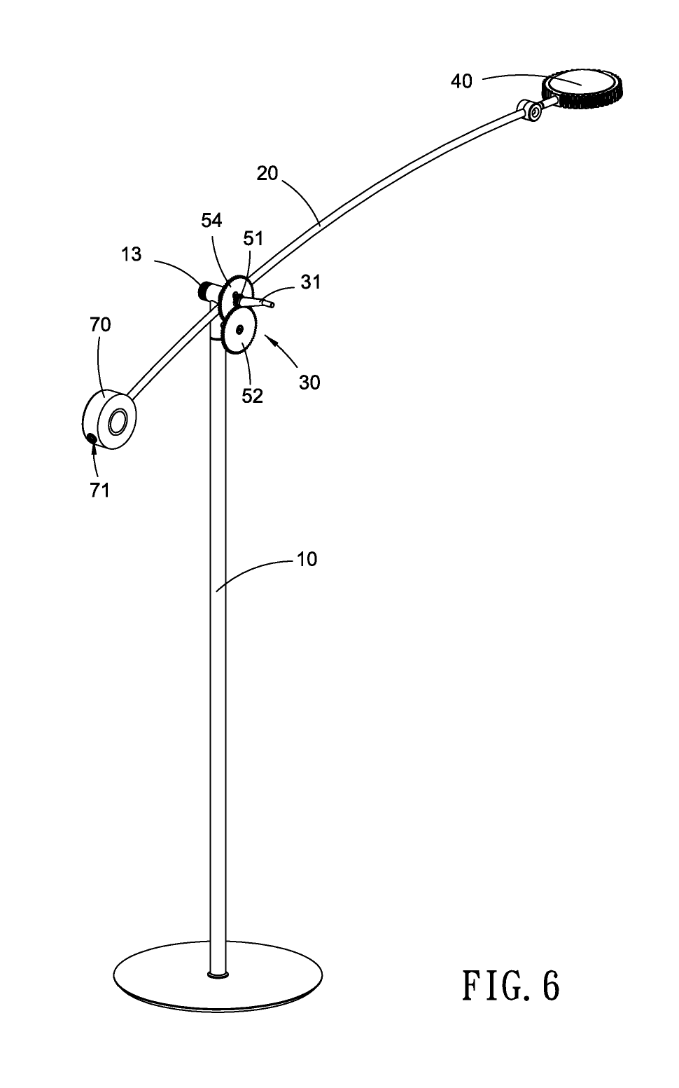

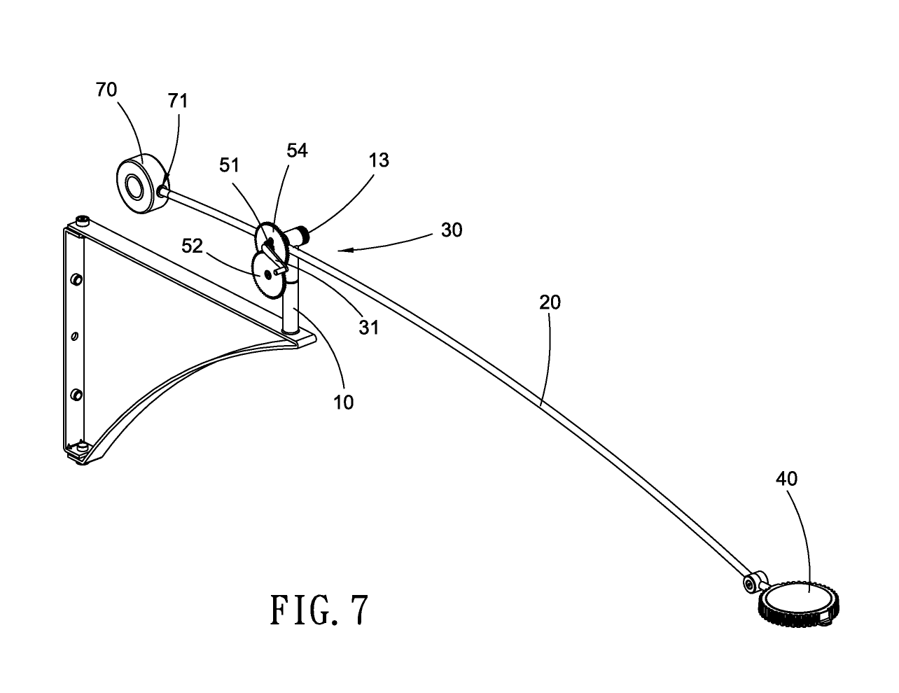

With reference to FIG. 1, an adjusting device for a lamp according to a first embodiment of the present invention comprises: a base 10, a rotary arm 20, and an adjuster 30, and the lamp is any one of a table lamp (as shown in FIG. 2), a floor lamp (as illustrated in FIG. 6), and a wall lamp (as shown in FIG. 7).

The base 10 includes a rotating shaft 11 rotatably connected thereon; the rotary arm 20 is mounted on the rotating shaft 11 and includes an illuminating member 40 fixed on a first end thereof, such that the rotary arm 20 is rotated along the rotating shaft 11 and supports the illuminating member 40, and the illuminating member 40 is any one of a lighting tube, a LED light bulb, and a traditional light bulb. The adjusting device of the present invention is employed to support the illuminating member 40 and to adjust a position of the illuminating member 40 relative to the base 10, such as a height of the illuminating member 40 relative to the base 10 and a distance between the illuminating member 40 and the base 10.

The adjuster 30 is disposed on one side of the base 10 and includes an operating portion 31, a first decelerating mechanism A1, and a second decelerating mechanism A2; wherein the operating portion 31 is manually rotated by a user, the first decelerating mechanism A1 has a first input segment A11 connected therewith and has a first output segment A12, such that the first decelerating mechanism A1 decelerates a first rotational movement of the operating portion 31, and the first output segment A12 outputs the first rotational movement; the second decelerating mechanism A2 has a second input segment A21 coupled with the first output segment A12 and has a second output segment A22, such that the second decelerating mechanism A2 decelerates the first rotational movement outputted by the first output segment A12, and the second output segment A12 outputs the first rotational movement to form a second rotational movement. In addition, the rotating shaft 11 is joined with the second output segment A11, and the second rotational movement drives the rotating shaft 11 to rotate, such that an angle of the rotary arm 20 relative to the base 10 is adjusted, thus adjusting the height of the illuminating member 40.

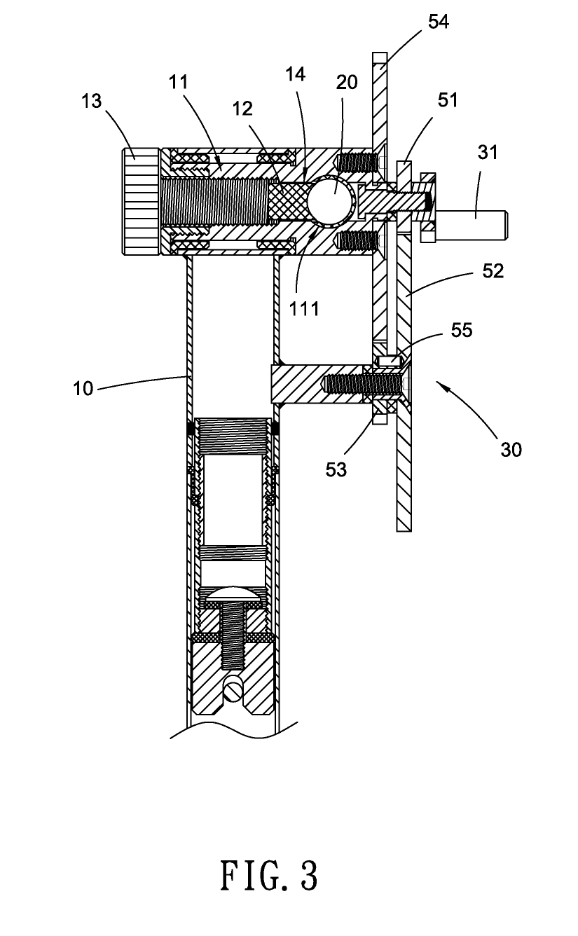

Referring further to FIGS. 2 and 3, the operating portion 31 is a swing bar manually rotated by the user and connected with the first decelerating mechanism A1, such that the operating portion 31 drives the first decelerating mechanism A1 and the second decelerating mechanism A2 to rotate. Each of the first decelerating mechanism A1 and the second decelerating mechanism A2 is a reduction gear mechanism, wherein the first decelerating mechanism A1 includes a first gear 51 and a second gear 52 meshing with the first gear 51; the second decelerating mechanism A2 includes a third gear 53 and a fourth gear 54 meshing with the third gear 53. In one embodiment, the first gear 51 is coaxial with the fourth gear 54 and rotates independently from the fourth gear 54, and the second gear 52 is coaxial and rotates with the third gear 53, wherein the second gear 52 and the third gear 53 are fixed together by ways of a bolt element 55 as illustrated in FIG. 3. Preferably, the second gear 52 and the third gear 53 may be also fixed together by using a rotary post. The first gear 51 is the first input segment A11 and is in connection with the operating portion 31, such that the first gear 51 is driven by the operating portion 31 to rotate. Since the first gear 51 meshes with the second gear 52, and a tooth number and a radius of the second gear 52 are greater than those of the first gear 51, after the first rotational movement of the operating portion 31 is decelerated, the second gear 52 outputs the first rotational movement which is decelerated, wherein the second gear 52 is the first output segment A12 of the first decelerating mechanism A1, the third gear 53 is the second input segment A21 of the second decelerating mechanism A2, such that the first rotational movement is passed to the third gear 53 of the second decelerating mechanism A2 via the second gear 52. Due to a tooth number and a radius of the fourth gear 54 are greater than those of the third gear 63, after the first rotational movement is inputted by the third gear 53 and is decelerated, the fourth gear 54 outputs the first rotational movement to form the second rotational movement. In one embodiment, the fourth gear 54 is coupled with the rotating shaft 11, so the second rotational movement drives the rotating shaft 11 to rotate, and then the rotating shaft 11 drives the rotary arm 20 and the illuminating member 11 to rotate, thus adjusting the height of the illuminating member 40 relative to the base 10.

In one embodiment, the rotary arm 20 is slidably disposed on the rotating shaft 11 of the base 10. For example, as shown in FIGS. 2 and 3, the rotary arm 20 is inserted through a through hole 111 of the rotating shaft 11, and the rotating shaft 11 has a slide block 12 and a forcing bolt 13 screwed thereon, such that the slide block 12 slides along the rotating shaft 11, and the forcing bolt 13 pushes the slide bock 12 to slide toward the rotary arm 20, hence the rotary arm 10 is forced in the through hole 111 or releases the rotary arm 10, thus adjusting the distance between the illuminating member 40 and the base 10.

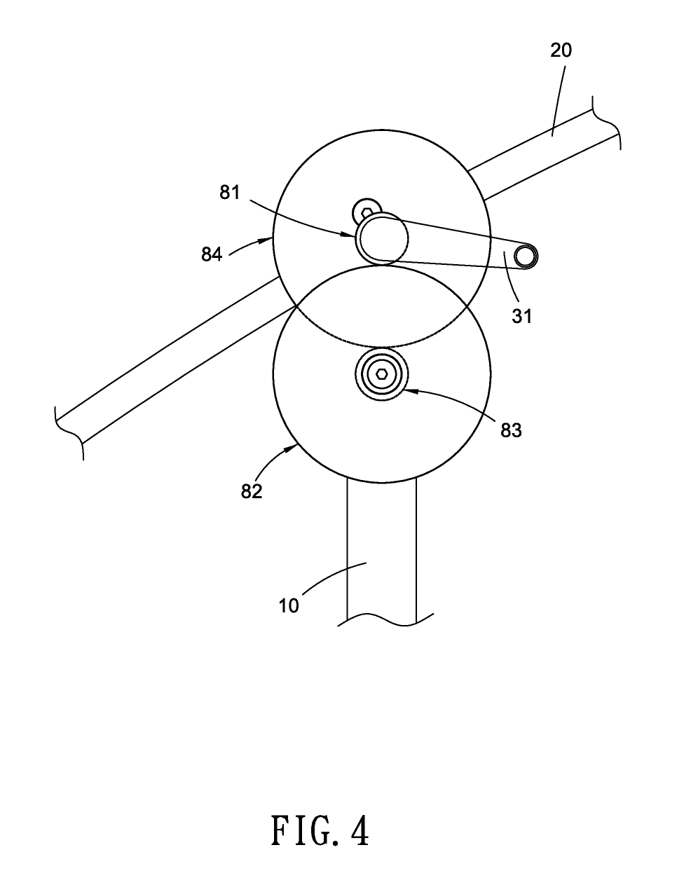

In a second embodiment, each of the first decelerating mechanism A1 and the second decelerating mechanism A2 is a friction wheel mechanism (as illustrated in FIG. 4), wherein the first decelerating mechanism A1 includes a first friction wheel 81 and a second friction wheel 82 frictions with the first friction wheel 81, and the second decelerating mechanism A1 includes a third friction wheel 83 and a fourth friction wheel 84 frictions with the third friction wheel 83.

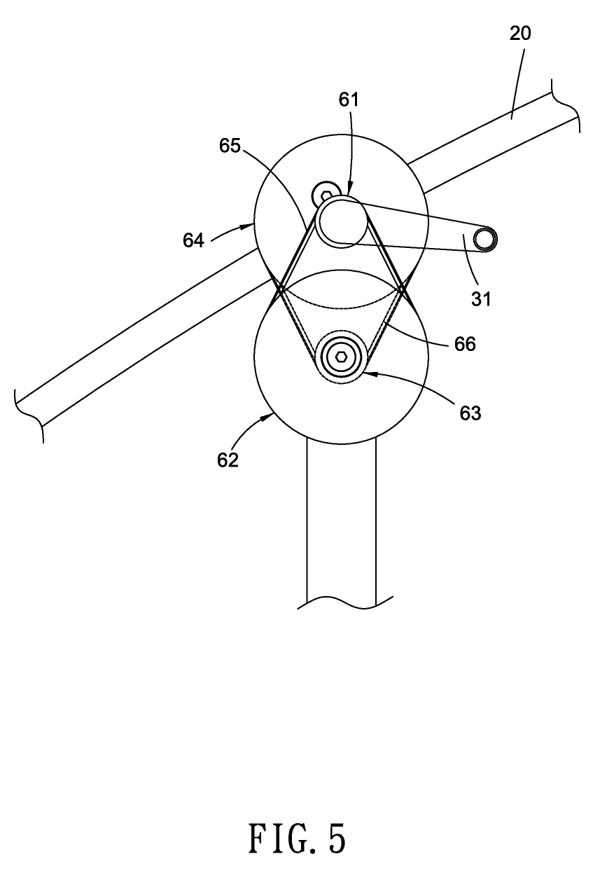

In a third embodiment, each of the first decelerating mechanism A1 and the second decelerating mechanism A2 is a belt pulley mechanism (as illustrated in FIG. 5), wherein the first decelerating mechanism A1 includes a first belt wheel 61, a second belt wheel 62, and a first driving belt 65 for driving the first belt wheel 61 and the second belt wheel 62; the second decelerating mechanism A2 includes a third belt wheel 63, a fourth belt wheel 64, and a second driving belt 66 for driving the third belt wheel 63 and the fourth belt wheel 64. Furthermore, the belt pulley mechanism may be replaced by a chain and a sprocket.

With reference to FIGS. 2, 6 and 7, a counterweight block 70 is secured on a second end of the rotary arm 20 opposite to the illuminating member 40 to balance a weight of the illuminating member 40 along the rotating shaft 11. In another embodiment, the counterweight block 70 is slidably mounted on the second end of the rotary arm, wherein the second end of the rotary arm 20 is inserted through an orifice 71 of the counterweight block 70. In another embodiment, the counterweight block 70 has a fixing element, such as a screw bolt (not shown) for screwing with the counterweight block 70, such that the rotary arm 20 is inserted through the counterweight block 70 and is screwed tightly or is unscrewed loosely to adjust a position of the counterweight block 70 relative to the rotating shaft 11, thus securing the rotary arm 20 and the illuminating member 40 stably.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. An adjusting device for a lamp being employed to support an illuminating member and to adjust a position of an illuminating member relative to a base, the adjusting device comprising: a base, a rotary arm, and an adjuster;
the base including a rotating shaft rotatably connected thereon; the rotary arm being mounted on the rotating shaft and including an illuminating member fixed on a first end thereof, such that the rotary arm is rotated along the rotating shaft and supports the illuminating member;
the adjuster being disposed on one side of the base and including an operating portion, a first decelerating mechanism, and a second decelerating mechanism; wherein the first decelerating mechanism drives the second decelerating mechanism, the second decelerating mechanism drives the rotating shaft to rotate, and the operating portion is rotatably connected with the first decelerating mechanism to drive the first decelerating mechanism and the second decelerating mechanism to rotate, such that second decelerating mechanism drives the rotating shaft to rotate, thus adjusting a height of the illuminating member relative to the base.

2. The adjusting device for the lamp as claimed in claim 1, wherein the rotary arm is inserted through a through hole of the rotating shaft, and the rotating shaft has a slide block and a forcing bolt screwed thereon, such that the slide block slides along the rotating shaft, and the forcing bolt pushes the slide bock to slide toward the rotary arm, hence the rotary arm is forced in the through hole or releases the rotary arm.

3. The adjusting device for the lamp as claimed in claim 1, wherein the operating portion is a swing bar connected with the first decelerating mechanism, such that the operating portion drives the first decelerating mechanism and the second decelerating mechanism to rotate.

4. The adjusting device for the lamp as claimed in claim 1, wherein each of the first decelerating mechanism and the second decelerating mechanism is a reduction gear mechanism.

5. The adjusting device for the lamp as claimed in claim 4, wherein the first decelerating mechanism includes a first gear and a second gear meshing with the first gear; the second decelerating mechanism includes a third gear and a fourth gear meshing with the third gear, the first gear is coaxial with the fourth gear and rotates independently from the fourth gear, and the second gear is coaxial and rotates with the third gear.

6. The adjusting device for the lamp as claimed in claim 5, wherein a tooth number and a radius of the second gear are greater than those of the first gear, and a tooth number and a radius of the fourth gear are greater than those of the third gear.

7. The adjusting device for the lamp as claimed in claim 1, wherein each of the first decelerating mechanism and the second decelerating mechanism is a friction wheel mechanism.

8. The adjusting device for the lamp as claimed in claim 1, wherein each of the first decelerating mechanism and the second decelerating mechanism is a belt pulley mechanism.

9. The adjusting device for the lamp as claimed in claim 8, wherein the first decelerating mechanism includes a first belt wheel, a second belt wheel, and a first driving belt for driving the first belt wheel and the second belt wheel; the second decelerating mechanism includes a third belt wheel, a fourth belt wheel, and a second driving belt for driving the third belt wheel and the fourth belt wheel, and wherein the first belt wheel is coaxial with the fourth belt wheel and rotates independently from the fourth belt wheel, and the second belt wheel is coaxial and rotates with the third belt wheel.

10. The adjusting device for the lamp as claimed in claim 1 further comprising a counterweight block secured on a second end of the rotary arm opposite to the illuminating member.
